(19) United States
(12) Patent Application Publication
(10) Pub. No.: US 2015/0334373 A1
(43) Pub. Date: Nov. 19, 2015

(54) IMAGE GENERATING APPARATUS, IMAGING APPARATUS, AND IMAGE GENERATING METHOD

(71) Applicant: Panasonic Intellectual Property Management Co., Ltd., Osaka (JP)

(72) Inventors: Kenichi KUBOTA, Osaka (JP); Yoshihiro MORIOKA, Nara (JP); Yusuke ONO, Osaka (JP)

(21) Appl. No.: 14/810,317

(22) Filed: Jul. 27, 2015

Related U.S. Application Data
(63) Continuation of application No. PCT/JP2014/001498, filed on Mar. 17, 2014.

(30) Foreign Application Priority Data
Mar. 19, 2013 (JP) 2013-056318

(51) Int. Cl. H04N 13/02; H04N 5/232; H04N 13/00

(52) U.S. Cl. CPC H04N 13/025; H04N 13/0239; H04N 13/0271; H04N 13/0296; H04N 13/004; H04N 5/23296; H04N 13/021; H04N 2013/0081; H04N 2013/0096

(57) ABSTRACT

An imaging apparatus includes primary imaging section, secondary imaging section, and image signal processor. The image signal processor is configured to, based on the primary image signal, cut out at least a part from the secondary image signal and generate a cutout image signal; determine whether or not either one of the primary image signal and the secondary image signal has a specific pattern; calculate parallax information based on the primary image signal and the cutout image signal, and correct the parallax information when the either one image signal is determined to have the specific pattern; and generate a new secondary image signal based on the primary image signal and one of the parallax information and the corrected parallax information.

### BACKGROUND

1. Field of the Disclosure

The present disclosure relates to an imaging apparatus that includes a plurality of imaging units and can capture an image for stereoscopic vision.

2. Background Art

Unexamined Japanese Patent Publication No. 2005-20606 (Patent Literature 1) discloses a digital camera that includes a main imaging unit and a sub imaging unit and generates a 3D image. This digital camera extracts parallax occurring between a main image signal obtained from the main imaging unit and a sub image signal obtained from the sub imaging unit. Based on the extracted parallax, a new sub image signal is generated from the main image signal, and a 3D image is generated from the main image signal and new sub image signal.

Unexamined Japanese Patent Publication No. 2005-210217 (Patent Literature 2) discloses a stereo camera that can perform stereoscopic photographing in a state where the right and left photographing magnifications are different from each other. This stereo camera includes a primary imaging means for generating primary image data, and a secondary imaging means for generating secondary image data whose angle of view is wider than that of the primary image data. The stereo camera cuts out, as third image data, a range corresponding to the primary image data from the secondary image data, and generates stereo image data from the primary image data and third image data.

Patent Literature 1 and Patent Literature 2 disclose a configuration where the main imaging unit (primary imaging means) has an optical zoom function and the sub imaging unit (secondary imaging means) does not have an optical zoom function but has an electronic zoom function.

### SUMMARY

The present disclosure provides an image generating apparatus and imaging apparatus that are useful for obtaining a high-quality image or moving image for stereoscopic vision from a pair of images or a pair of moving images that are captured by a pair of imaging sections having different optical characteristics and different specifications of imaging elements.

The imaging generating apparatus of the present disclosure includes an image signal processor. The image signal processor is configured to receive a primary image signal and a secondary image signal having a resolution higher than a resolution of the primary image signal and an angle of view wider than or equal to an angle of view of the primary image signal; based on the primary image signal, cut out at least a part from the secondary image signal and generate a cutout image signal; determine whether or not either one of the primary image signal and the secondary image signal has a specific pattern; calculate parallax information based on the primary image signal and the cutout image signal, and correct the parallax information when the either one image signal is determined to have the specific pattern; and generate a new secondary image signal based on the primary image signal and one of the parallax information and the corrected parallax information.

The imaging apparatus of the present disclosure includes a primary imaging section, a secondary imaging section, and an image signal processor. The primary imaging section is configured to capture a primary image and output a primary image signal. The secondary imaging section is configured to capture a secondary image having an angle of view wider than or equal to that of the primary image at a resolution higher than that of the primary image, and output a secondary image signal. The image signal processor is configured to, based on the primary image signal, cut out at least a part from the secondary image signal and generate a cutout image signal; determine whether or not either one of the primary image signal and the secondary image signal has a specific pattern; calculate parallax information based on the primary image signal and the cutout image signal, and correct the parallax information when the either one image signal is determined to have the specific pattern; and generate a new secondary image signal based on the primary image signal and one of the parallax information and the corrected parallax information.

The image signal processor may include a feature point extracting unit, an angle-of-view adjusting unit, an image pattern determining unit, a depth map generating unit, and an image generating unit. The feature point extracting unit is configured to extract, from the primary image signal and secondary image signal, a feature point common between the primary image signal and secondary image signal. The angle-of-view adjusting unit is configured to, based on the feature point and primary image signal, cut out at least a part from the secondary image signal and generate a cutout image signal. The image pattern determining unit is configured to determine whether or not either one of the primary image signal and the secondary image signal has a specific pattern. The depth map generating unit is configured to calculate parallax information based on the primary image signal and the cutout image signal and generate a depth map, and to correct the parallax information when the image pattern determining unit determines that the either one image signal has the specific pattern. The image generating unit is configured to generate a new secondary image signal based on the primary image signal and one of the parallax information and the corrected parallax information.

The image generating method of the present disclosure includes:
based on a primary image signal, cutting out at least a part from a secondary image signal and generating a cutout image signal, the secondary image signal having a resolution higher than a resolution of the primary image signal and an angle of view wider than or equal to an angle of view of the primary image signal;
determining whether or not either one of the primary image signal and the secondary image signal has a specific pattern;
calculating parallax information based on the primary image signal and the cutout image signal, and correcting the parallax information when the either one image signal is determined to have the specific pattern; and
generating a new secondary image signal based on the primary image signal and one of the parallax information and the corrected parallax information.

### BRIEF DESCRIPTION OF DRAWINGS

FIG. 1 is an outward appearance of an imaging apparatus in accordance with a first exemplary embodiment.

FIG. 2 is a diagram schematically showing a circuit configuration of the imaging apparatus in accordance with the first exemplary embodiment.

FIG. 3 is a diagram showing the configuration of the imaging apparatus in accordance with the first exemplary embodiment while each function is shown by each block.

FIG. 4 is a flowchart illustrating the operation when a stereoscopic image is captured by the imaging apparatus in accordance with the first exemplary embodiment.

FIG. 5 is a diagram schematically showing one example of the processing flow of an image signal in the imaging apparatus in accordance with the first exemplary embodiment.

FIG. 6 is an outward appearance of an imaging apparatus in accordance with another exemplary embodiment.

FIG. 7 is a diagram schematically showing one example of the processing flow of an image signal in the imaging apparatus in accordance with another exemplary embodiment.

### DETAILED DESCRIPTION

Hereinafter, the exemplary embodiments will be described in detail appropriately with reference to the accompanying drawings. Description more detailed than necessary is sometimes omitted. For example, a detailed description of a well-known item and a repeated description of substantially the same configuration are sometimes omitted. This is for the purpose of preventing the following descriptions from becoming more redundant than necessary and allowing persons skilled in the art to easily understand the exemplary embodiments.

The accompanying drawings and the following descriptions are provided to allow the persons skilled in the art to sufficiently understand the present disclosure. It is not intended that they restrict the main subject described within the scope of the claims.

### First Exemplary Embodiment

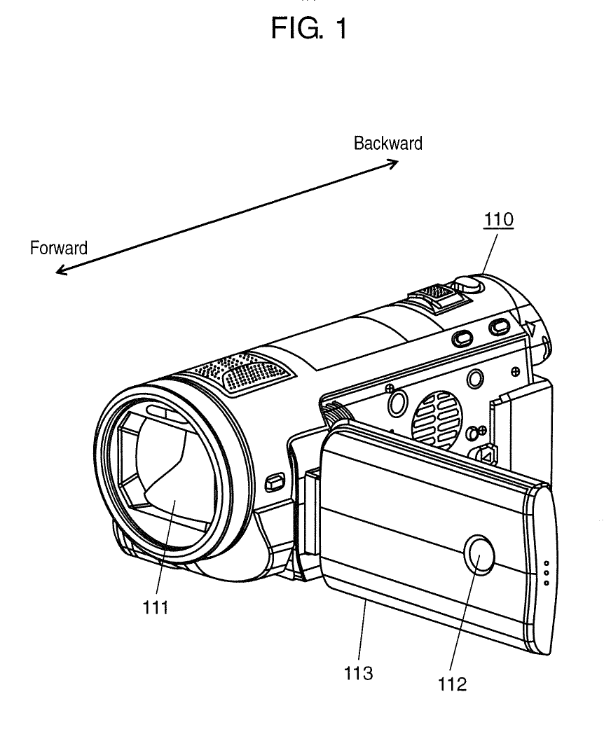

The first exemplary embodiment is hereinafter described using FIG. 1 to FIG. 5.

[1-1. Configuration]

FIG. 1 is an outward appearance of imaging apparatus 110 in accordance with the first exemplary embodiment.

Imaging apparatus 110 includes monitor 113, an imaging section (hereinafter referred to as “primary imaging section”) including primary lens unit 111, and an imaging section (hereinafter referred to as “secondary imaging section”) including secondary lens unit 112. Imaging apparatus 110 thus includes a plurality of imaging sections, and each imaging section can capture a still image and shoot a video.

Primary lens unit 111 is disposed in a front part of the main body of imaging apparatus 110 so that the imaging direction of the primary imaging section is the forward direction.

Monitor 113 is openably/closably disposed in the main body of imaging apparatus 110, and includes a display (not shown in FIG. 1) for displaying a captured image. The display is disposed on the surface of monitor 113 that is on the opposite side to the imaging direction of the primary imaging section when monitor 113 is open, namely on the side on which a user (not shown) staying at the back of imaging apparatus 110 can observe the display.

Secondary lens unit 112 is disposed on the side of monitor 113 opposite to the installation side of the display, and is configured to face the same direction as the imaging direction of the primary imaging section when monitor 113 is open.

In imaging apparatus 110, the primary imaging section is set as a main imaging section, and the secondary imaging section is set as a sub imaging section. As shown in FIG. 1, when monitor 113 is open, using the two imaging sections allows the capturing of a still image for stereoscopic vision (hereinafter referred to as “stereoscopic image”) and the shooting of video for stereoscopic vision (hereinafter referred to as “stereoscopic video”). The primary imaging section as the main imaging section has an optical zoom function. The user can set the zoom magnification of the zoom function at any value, and perform the still image capturing or video shooting.

In the present exemplary embodiment, an example is described where the primary imaging section captures an image of right-eye view and the secondary imaging section captures an image of left-eye view. Therefore, as shown in FIG. 1, in imaging apparatus 110, primary lens unit 111 is disposed on the right side of the imaging direction and secondary lens unit 112 is disposed on the left side of the imaging direction. The present exemplary embodiment is not limited to this configuration. A configuration may be employed in which the primary imaging section captures an image of left-eye view and the secondary imaging section captures an image of right-eye view. Hereinafter, an image captured by the primary imaging section is referred to as “primary image”, and an image captured by the secondary imaging section is referred to as “secondary image”.

Secondary lens unit 112 of the secondary imaging section as the sub imaging section has an aperture smaller than that of primary lens unit 111, and does not have an optical zoom function. Therefore, the installation volume required by the secondary imaging section is smaller than that of the primary imaging section, so that the secondary imaging section can be mounted on monitor 113.

In the present exemplary embodiment, the image of right-eye view captured by the primary imaging section is used as a right-eye image constituting a stereoscopic image, but the image of left-eye view captured by the secondary imaging section is not used as a left-eye image constituting the stereoscopic image. In the present exemplary embodiment, the parallax amount (displacement amount) is calculated by comparing the image of right-eye view captured by the primary imaging section with the image of left-eye view captured by the secondary imaging section, and a left-eye image is generated from the primary image on the basis of the calculated parallax amount, thereby generating a stereoscopic image (details are described later).

The parallax amount (displacement amount) means the magnitude of the positional displacement of a subject that occurs when the primary image and secondary image are overlaid on each other at the same angle of view. This displacement is caused by the difference (parallax) between the disposed position of the primary imaging section and that of the secondary imaging section. In order to generate a stereoscopic image that produces a natural stereoscopic effect, preferably, the optical axis of the primary imaging section and the optical axis of the secondary imaging section are set so as to be horizontal to the ground—like the parallax direction of persons—and so as to separate from each other by an extent similar to the width between the right eye and left eye.

Therefore, in imaging apparatus 110, primary lens unit 111 and secondary lens unit 112 are disposed so that the optical centers thereof are located on substantially the same horizontal plane (plane horizontal to the ground) when the user normally holds imaging apparatus 110 (namely, holds it in a stereoscopic image capturing state). The disposed positions of primary lens unit 111 and secondary lens unit 112 are set so that the distance between the optical centers thereof is 30 mm or more and 65 mm or less.

In order to generate a stereoscopic image that produces a natural stereoscopic effect, preferably, the distance between the disposed position of primary lens unit 111 and the subject is substantially the same as that between the disposed position of secondary lens unit 112 and the subject. Therefore, in imaging apparatus 110, primary lens unit 111 and secondary lens unit 112 are disposed so as to substantially satisfy the epipolar constraint. In other words, primary lens unit 111 and secondary lens unit 112 are disposed so that each optical center is located on one plane substantially parallel with the imaging surface of the imaging element that is included in the primary imaging section or the imaging element that is included in the secondary imaging section.

These conditions do not need to be strictly satisfied, and an error is allowed within a range where no problem arises in practical use. Even if these conditions are not satisfied, the image at this time can be converted into an image satisfying the conditions by executing affine transformation. In the affine transformation, the scaling, rotation, or parallel shift of an image is performed by calculation. The parallax amount (displacement amount) is calculated using the image having undergone the affine transformation.

In imaging apparatus 110, primary lens unit 111 and secondary lens unit 112 are disposed so that the optical axis of the primary imaging section and the optical axis of the secondary imaging section are parallel with each other (hereinafter referred to as “parallel method”). However, primary lens unit 111 and secondary lens unit 112 may be disposed so that the optical axis of the primary imaging section and the optical axis of the secondary imaging section cross each other at one predetermined point (hereinafter referred to as “cross method”). The image captured by the parallel method can be converted, by the affine transformation, into an image that looks as if it were captured by the cross method.

Regarding the primary image and secondary image that are captured in a state where these conditions are satisfied, the position of the subject substantially satisfies the epipolar constraint condition. In this case, in the generating process of a stereoscopic image (described later), when the position of the subject is determined based on one image (e.g. primary image), the position of the subject determined based on the other image (e.g. secondary image) can be relatively easily calculated. Therefore, the operation amount can be reduced in the generating process of the stereoscopic image. Conversely, as the number of items that do not satisfy the conditions increases, the operation amount of the affine transformation or the like increases. Therefore, the operation amount increases in the generating process of the stereoscopic image.

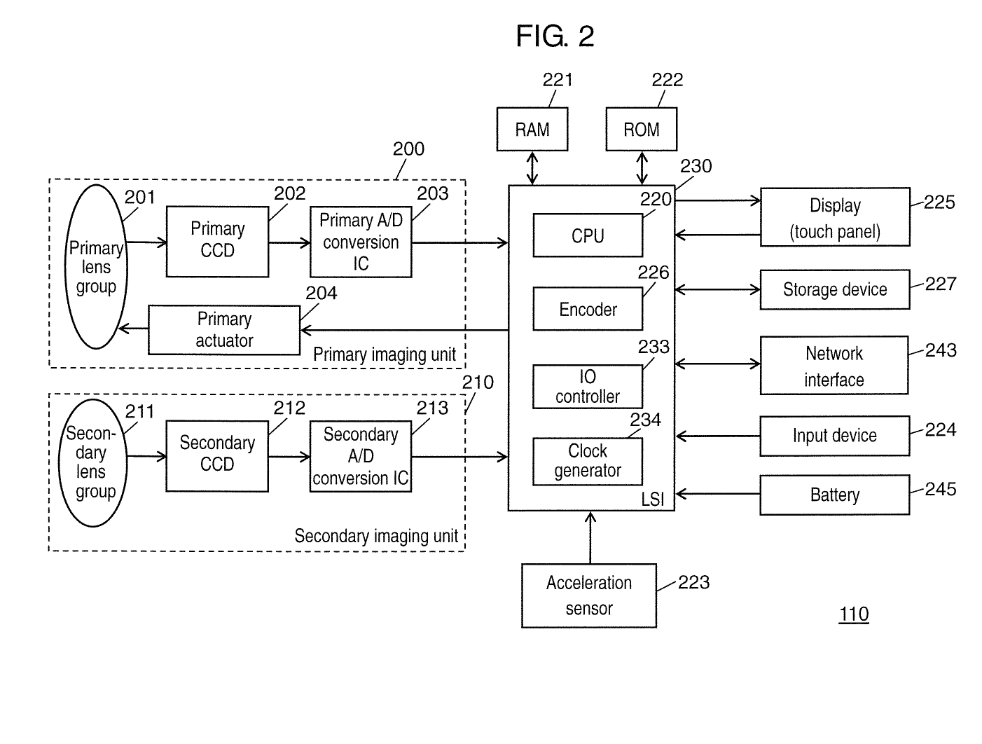

FIG. 2 is a diagram schematically showing a circuit configuration of imaging apparatus 110 in accordance with the first exemplary embodiment.

Imaging apparatus 110 includes primary imaging unit 200 as the primary imaging section, secondary imaging unit 210 as the secondary imaging section, LSI (Large Scale Integration) 230, RAM (Random Access Memory) 221, ROM (Read Only Memory) 222, acceleration sensor 223, display 225, storage device 227, input device 224, network interface 243, and battery 245.

Primary imaging unit 200 includes primary lens group 201, primary CCD (Charge Coupled Device) 202 as a primary imaging element, primary A/D conversion IC (integrated circuit) 203, and primary actuator 204.

Primary lens group 201 corresponds to primary lens unit 111 shown in FIG. 1, and is an optical system formed of a plurality of lenses that include a zoom lens allowing optical zoom and a focus lens allowing focus adjustment. Primary lens group 201 includes an optical diaphragm (not shown) for adjusting the quantity of light (light quantity) received by primary CCD 202. The light taken through primary lens group 201 is formed as a subject image on the imaging surface of primary CCD 202 after the adjustments of the optical zoom, focus, and light quantity are performed by primary lens group 201. This image is the primary image.

Primary CCD 202 is configured to convert the light having been received on the imaging surface into an electric signal and output it. This electric signal is an analog signal whose voltage value varies depending on the intensity of light (light quantity).

Primary A/D conversion IC 203 is configured to convert, into a digital electric signal, the analog electric signal output from primary CCD 202. The digital signal is the primary image signal.

Primary actuator 204 includes a motor configured to drive the zoom lens and focus lens that are included in primary lens group 201. This motor is controlled with a control signal output from CPU (Central Processing Unit) 220 of LSI 230.

In the present exemplary embodiment, the following description is performed assuming that primary imaging unit 200 converts the primary image into the image signal “the number of horizontal pixels is 1,920 and the number of vertical pixels is 1,080”. Primary imaging unit 200 is configured to perform not only still image capturing but also video shooting, and can perform the video shooting at a frame rate (e.g. 60 Hz) similar to that of general video. Therefore, primary imaging unit 200 can shoot high-quality and smooth video. Here, the frame rate means the number of images captured in a unit time (e.g. 1 sec). When the video shooting is performed at a frame rate of 60 Hz, 60 images are consecutively captured per second.

The number of pixels in the primary image and the frame rate during the video shooting are not limited to the above-mentioned numerical values. Preferably, they are set appropriately depending on the specification or the like of imaging apparatus 110.

Secondary imaging unit 210 includes secondary lens group 211, secondary CCD 212 as a secondary imaging element, and secondary A/D conversion IC 213.

Secondary lens group 211 corresponds to secondary lens unit 112 shown in FIG. 1, and is an optical system that is formed of one or a plurality of lenses including a deep-focus lens requiring no focus adjustment. The light taken through secondary lens group 211 is formed as a subject image on the imaging surface of secondary CCD 212. This image is the secondary image.

Secondary lens group 211 does not have an optical zoom function, as discussed above. Therefore, secondary lens group 211 does not have an optical zoom lens but has a single focus lens. Secondary lens group 211 is also formed of a lens group smaller than primary lens group 201, and the objective lens of secondary lens group 211 has an aperture smaller than that of the objective lens of primary lens group 201. Thus, secondary imaging unit 210 is made smaller than primary imaging unit 200 and whole imaging apparatus 110 is downsized, and hence the convenience (portability or operability) is improved and the degree of freedom in the disposed position of secondary imaging unit 210 is increased. Thus, as shown in FIG. 1, secondary imaging unit 210 can be mounted on monitor 113.

Secondary CCD 212 is configured to convert the light having been received on the imaging surface into an analog electric signal and output it, similarly to primary CCD 202. Secondary CCD 212 of the present exemplary embodiment has a resolution higher than that of primary CCD 202. Therefore, the image signal of the secondary image has a resolution higher than that of the image signal of the primary image, and has more pixels than that of the image signal of the primary image. This is for the purpose of extracting and using a part of the image signal of the secondary image or enlarging the image by electronic zoom. The details are described later.

Secondary A/D conversion IC 213 is configured to convert, into a digital electric signal, the analog electric signal output from secondary CCD 212. This digital signal is the secondary image signal.

In the present exemplary embodiment, the following description is performed assuming that secondary imaging unit 210 converts the secondary image into the image signal “the number of horizontal pixels is 7,680 and the number of vertical pixels is 4,320”. Similarly to primary imaging unit 200, secondary imaging unit 210 is configured to perform not only still image capturing but also video shooting. However, since the secondary image signal has a resolution higher than that of the primary image signal and has more pixels than that of the primary image signal, the frame rate (e.g. 30 Hz) during the video shooting by secondary imaging unit 210 is lower than the frame rate during the video shooting by primary imaging unit 200.

The number of pixels in the secondary image and the frame rate during the video shooting are not limited to the above-mentioned numerical values. Preferably, they are set appropriately depending on the specification or the like of imaging apparatus 110.

In the present exemplary embodiment, a series of operations in which the subject image formed on the imaging surface of an imaging element is converted into an electric signal and the electric signal is output as an image signal from an A/D conversion IC are referred to as “capture”. The primary imaging section captures the primary image and outputs the primary image signal, and the secondary imaging section captures the secondary image and outputs the secondary image signal.

The present exemplary embodiment has described the example where a CCD is used for each of the primary imaging element and secondary imaging element. However, the primary imaging element and secondary imaging element may be any imaging elements as long as they convert the received light into an electric signal, and may be CMOSs (Complementary Metal Oxide Semiconductors) or the like, for example.

ROM (Read Only Memory) 222 is configured so that various data such as a program and parameter for operating CPU 220 is stored in ROM 222 and CPU 220 can optionally read the data. ROM 222 is formed of a non-volatile semiconductor memory element, and the stored data is kept even if the power supply of imaging apparatus 110 is turned off.

Input device 224 is a generic name for an input device configured to receive a command from the user. Input device 224 includes various buttons such as a power supply button and setting button, a touch panel, and a lever that are operated by the user. In the present exemplary embodiment, an example where the touch panel is disposed on display 225 is described. However, input device 224 is not limited to these configurations. For example, input device 224 may include a voice input device. Alternatively, input device 224 may have a configuration where all input operations are performed with a touch panel, or a configuration where a touch panel is not disposed and all input operations are performed with a button or a lever.

LSI 230 includes CPU 220, encoder 226, IO (Input Output) controller 233, and clock generator 234.

CPU (Central Processing Unit) 220 is configured to operate based on a program or parameter that is read from ROM 222 or a command of the user that is received by input device 224, and to perform the control of whole imaging apparatus 110 and various arithmetic processing. The various arithmetic processing includes image signal processing related to the primary image signal and secondary image signal. The details of the image signal processing are described later.

In the present exemplary embodiment, a microcomputer is used as CPU 220. However, CPU 220 may be configured to perform a similar operation using, instead of the microcomputer, an FPGA (Field Programmable Gate Array), DSP (Digital Signal Processor), or GPU (Graphics Processing Unit). Alternatively, a part or the whole of the processing of CPU 220 may be performed with a device outside imaging apparatus 110.

Encoder 226 is configured to encode, in a predetermined method, an image signal based on the image captured by imaging apparatus 110, or information related to the captured image. This is for the purpose of reducing the data amount stored in storage device 227. The encoding method is a generally used image compression method, for example, MPEG (Motion Picture Experts Group) -2 or H. 264/MPEG-4 AVC.

IO (Input Output) controller 233 controls the input and output of an input signal and output signal of LSI 230 (CPU 220).

Clock generator 234 generates a clock signal, and supplies it to LSI 230 (CPU 220) or a circuit block connected to LSI 230. This clock signal is used as a synchronizing signal for synchronizing various operations and various arithmetic processing in LSI 230 (CPU 220).

RAM (Random Access Memory) 221 is formed of a volatile semiconductor memory element. RAM 221 is configured to, based on a command from CPU 220, temporarily store a part of the program for operating CPU 220, a parameter during the execution of the program, and a command of the user. Data stored in RAM 221 is optionally readable by CPU 220, and is optionally rewritable in response to the command of CPU 220.

Acceleration sensor 223 is a generally used acceleration detection sensor, and is configured to detect the motion and attitude change of imaging apparatus 110. For example, acceleration sensor 223 detects whether imaging apparatus 110 is kept in parallel with the ground, and the detection result is displayed on display 225. Therefore, the user can judge, by watching the display, whether imaging apparatus 110 is kept in parallel with the ground, namely whether imaging apparatus 110 is in a state (attitude) appropriate for capturing a stereoscopic image. Thus, the user can capture a stereoscopic image or shoot stereoscopic video while keeping imaging apparatus 110 in an appropriate attitude.

Imaging apparatus 110 may be configured to perform the optical control such as a shake correction based on the detection result by acceleration sensor 223. Acceleration sensor 223 may be a gyroscope of three axial directions (triaxial gyro-sensor), or may have a configuration where a plurality of sensors are used in combination with each other.

Display 225 is formed of a generally used liquid crystal display panel, and is mounted on monitor 113 of FIG. 1. Display 225 includes the touch panel attached on its surface, and is configured to simultaneously perform the image display and the reception of a command from the user. Images displayed on display 225 include the following images:
(1) an image being captured by imaging apparatus 110 (image based on the image signal that is output from primary imaging unit 200 or secondary imaging unit 210);
(2) an image based on the image signal that is stored in storage device 227;
(3) an image based on the image signal that is signal-processed by CPU 220; and
(4) a menu display screen for displaying various set items of imaging apparatus 110.
   On display 225, these images are selectively displayed or a plurality of images are displayed in an overlapping state. Display 225 is not limited to the above-mentioned configuration, but may be a thin image display device of low power consumption. For example, display 225 may be formed of an EL (Electro Luminescence) panel or the like. Display 225 may be configured to display a stereoscopic image.

Storage device 227 is formed of a hard disk drive (HDD) as a storage device that is optionally rewritable and has a relatively large capacity, and is configured to readably store the data or the like encoded by encoder 226. The data stored in storage device 227 includes the image signal of a stereoscopic image generated by CPU 220, the information required for displaying the stereoscopic image, and image information accompanying the image signal. Storage device 227 may be configured to store the image signal that is output from primary imaging unit 200 or secondary imaging unit 210 without applying the encoding processing to it. Storage device 227 is not limited to the HDD. For example, storage device 227 may be configured to store data in an attachable/detachable storage medium such as a memory card having a built-in semiconductor memory element or optical disc.

The image information means information related to an image signal. For example, this image information includes type of an image encoding method, bit rate, image size, resolution, frame rate, focusing distance during capturing (distance to a focused subject), zoom magnification, and whether or not the image is a stereoscopic image. Furthermore, when the image is a stereoscopic image, the image information includes an identifier of a left-eye image and aright-eye image, and parallax information. One or more of these parameters are, as the image information, associated with the image signal, and stored in storage device 227.

The information (database) which is referred to during the image signal processing (described later) is previously stored in storage device 227. In this database, the information used for correcting parallax information (depth map) (described later) and the information referred to by a scene determining unit (described later) are stored, and are associated with a feature point (described later) and a pattern in a captured image (scene imaged in the captured image). This database is described later.

This database may be stored in a storage device that is disposed separately from storage device 227 for storing the image signal and image information described above.

Network interface 243 is a typical communication device, and performs delivery and reception of data between imaging apparatus 110 and an apparatus disposed on outside of imaging apparatus 110. The data includes data stored in storage device 227, data processed by CPU 220, and data input from an external apparatus to imaging apparatus 110.

Battery 245 is a power supply device formed of a generally used secondary battery, and supplies electric power required for the operation of imaging apparatus 110.

[1-2. Operation]

The operation of imaging apparatus 110 having such a configuration is described.

Hereinafter, a main operation performed when a stereoscopic image is captured by imaging apparatus 110 is described while each function is shown by each block.

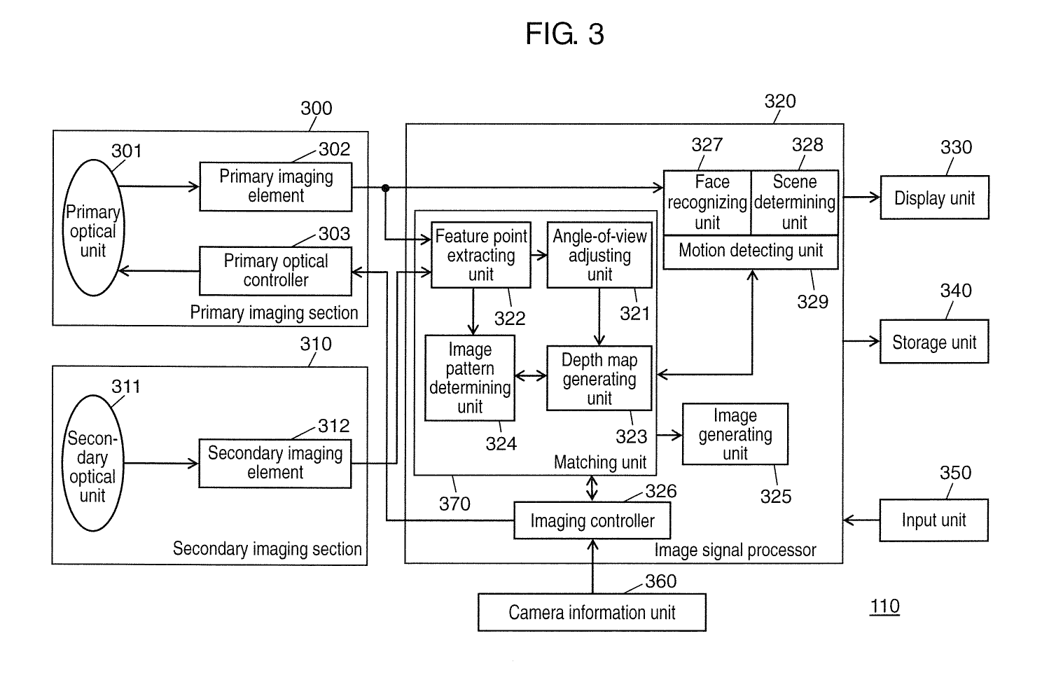

FIG. 3 is a diagram showing the configuration of imaging apparatus 110 in accordance with the first exemplary embodiment while each function is shown by each block.

When the configuration of imaging apparatus 110 is divided into main functions operating during the capturing of a stereoscopic image, imaging apparatus 110 can be mainly divided into seven blocks: primary imaging section 300, secondary imaging section 310, image signal processor 320, display unit 330, storage unit 340, input unit 350, and camera information unit 360, as shown in FIG. 3.

Image signal processor 320 temporarily stores an image signal in a storage element such as a frame memory when the image signal is processed, but such a storage element is omitted in FIG. 3. Furthermore, a component (battery 245 or the like) that is not directly related to the capturing of a stereoscopic image is omitted.

Primary imaging section 300 includes primary optical unit 301, primary imaging element 302, and primary optical controller 303. Primary imaging section 300 corresponds to primary imaging unit 200 shown in FIG. 2. Primary optical unit 301 corresponds to primary lens group 201, primary imaging element 302 corresponds to primary CCD 202 and primary A/D conversion IC 203, and primary optical controller 303 corresponds to primary actuator 204. In order to avoid the repetition, the descriptions of these components are omitted.

Secondary imaging section 310 includes secondary optical unit 311 and secondary imaging element 312. Secondary imaging section 310 corresponds to secondary imaging unit 210 shown in FIG. 2. Secondary optical unit 311 corresponds to secondary lens group 211, and secondary imaging element 312 corresponds to secondary CCD 212 and secondary A/D conversion IC 213. In order to avoid the repetition, the descriptions of these components are omitted.

Display unit 330 corresponds to display 225 shown in FIG. 2. Input unit 350 corresponds to input device 224 shown in FIG. 2. A touch panel included in input unit 350 is attached on the surface of display unit 330, and display unit 330 can simultaneously perform the display of an image and the reception of a command from the user. Camera information unit 360 corresponds to acceleration sensor 223 shown in FIG. 2. Storage unit 340 corresponds to storage device 227 shown in FIG. 2. In order to avoid the repetition, the descriptions of these components are omitted.

Image signal processor 320 corresponds to LSI 230 shown in FIG. 2. The operation performed by image signal processor 320 of FIG. 3 is mainly performed by CPU 220. Therefore, the operation performed by CPU 220 is mainly described, and descriptions of the operations by encoder 226, JO controller 233, and clock generator 234 are omitted.

CPU 220 performs the control of whole imaging apparatus 110 and various arithmetic processing. In FIG. 3, however, only main functions are described while the functions are classified into respective blocks. The main functions are related to the arithmetic processing (image signal processing) and control operation that are performed by CPU 220 when a stereoscopic image is captured by imaging apparatus 110. The functions related to the other operations are omitted. This is for the purpose of intelligibly describing the operation when a stereoscopic image is captured by imaging apparatus 110.

The function blocks shown in image signal processor 320 in FIG. 3 simply indicate main functions of the arithmetic processing and control operation that are performed by CPU 220. The inside of CPU 220 is not physically divided into the function blocks shown in FIG. 3. For the sake of convenience, however, the following description is performed assuming that image signal processor 320 includes the units shown in FIG. 3.

CPU 220 may be formed of an IC or FPGA including an electronic circuit corresponding to each function block shown in FIG. 3.

As shown in FIG. 3, image signal processor 320 includes matching unit 370, face recognizing unit 327, scene determining unit 328, motion detecting unit 329, image generating unit 325, and imaging controller 326.

Matching unit 370 includes feature point extracting unit 322, angle-of-view adjusting unit 321, image pattern determining unit 324, and depth map generating unit 323.

Face recognizing unit 327 detects from a primary image signal whether or not the face of a person is included in a subject captured as a primary image. The detection of the face of a person can be performed using a generally used method, so that the detailed descriptions are omitted. The generally used method is the detection by template matching of the eye, nose, mouth, eyebrow, profile, or hairstyle, or the detection of the color of the skin, for example. When face recognizing unit 327 detects the faces of persons, it detects the positions and sizes of the faces of the persons and the number of faces, and also calculates the reliability (the probability that each face is certainly the face of the person). The detection result of face recognizing unit 327 is output to scene determining unit 328 and matching unit 370. The detection result of face recognizing unit 327 may be used for an autofocus adjusting function or the like.

Motion detecting unit 329 performs motion detection related to the primary image signal. Based on two or more primary images that are temporally consecutively captured, motion detecting unit 329 determines whether each pixel or each block is still or moving by one-pixel matching or by block matching using a group of a plurality of pixels. For the pixel or block determined to be moving, the motion vector is detected. The motion detection itself is a generally known method, so that the detailed descriptions are omitted. The detection result of motion detecting unit 329 is output to scene determining unit 328 and matching unit 370. The detection result of motion detecting unit 329 may be used for the autofocus adjusting function or the like.

In order to acquire these primary image signals, imaging apparatus 110 may be configured to automatically capture second or later temporally consecutive primary images after the capturing of the primary images.

Scene determining unit 328 determines which scene is captured in the primary image on the basis of the primary image signal, the detection result of face recognizing unit 327, and the detection result of motion detecting unit 329.

Scene determining unit 328 classifies primary images into the following four groups:
(1) a captured image of a landscape;
(2) a captured image of a person;
(3) a captured image of a scene having much motion; and
(4) the other images.
   The determination result of scene determining unit 328 is output to matching unit 370.

Scene determining unit 328 performs the above-mentioned determination on the basis of the followings:
the detection result of face recognizing unit 327 and the detection result of motion detecting unit 329;
the histogram of the primary image signal with respect to the luminance signal;
the histogram of the primary image signal with respect to the color signal (color-difference signal);
the signal obtained by extracting the profile part from the primary image signal; and
the optical zoom magnification of primary optical unit 301 and the distance to a focused subject when the primary image to be determined is captured.
   The information required for the determination is included in the above-mentioned database, and scene determining unit 328 performs the determination by reference to the database.

The image classification by scene determining unit 328 is not limited to the above-mentioned contents. For example, the image classification may be performed based on the color or brightness of the captured image, namely images may be classified into an image having a large red part, a dark image, or an image having large green and blue parts. Furthermore, the number of groups may be increased from four by adding a captured image of a child, a captured image of still life such as a decorative object, and a captured image of a night view. Another classification may be performed. The information used for the determination of the classification is not limited to the above-mentioned information. Information other than the above-mentioned one may be used, or one or more pieces of the above-mentioned information may be selected and used. Scene determining unit 328 may be configured to perform the above-mentioned determination on the basis of the secondary image or both of the primary image and secondary image.

Imaging apparatus 110 can acquire, during focus adjustment, the focusing distance that is the distance from imaging apparatus 110 to the focused subject. The distance (focusing distance) from imaging apparatus 110 to the subject focused on the imaging surface of primary imaging element 302 varies depending on the position of the focus lens. Therefore, when the information that associates the position of the focus lens with the focusing distance is previously stored in imaging controller 326 (or primary optical controller 303), the following operation is allowed:
when imaging controller 326 controls the optical zoom lens and focus lens of primary optical unit 301 via primary optical controller 303, image signal processor 320 can acquire the present focusing distance on the basis of the present position of the focus lens.

Thus, image signal processor 320 can acquire, as supplementary information of the primary image, the optical zoom magnification and focusing distance of primary optical unit 301 when the primary image is captured.

Image generating unit 325 generates a new secondary image signal from the primary image signal on the basis of the parallax information (depth map) output from depth map generating unit 323 of matching unit 370. Hereinafter, the new secondary image signal generated from the primary image signal is referred to as “new secondary image signal”. The image based on the new secondary image signal is referred to as “new secondary image”. Therefore, the primary image signal and new secondary image signal have the same specification (resolution and angle of view, and, in the case of video, frame rate).

In the present exemplary embodiment, image generating unit 325 outputs the stereoscopic image signal in which the right-eye image signal is set to be the primary image signal and the left-eye image signal is set to be the new secondary image signal. The new secondary image signal is generated based on the parallax information (depth map) by image generating unit 325, as discussed above.

This stereoscopic image signal is stored in storage device 340, for example, and the stereoscopic image based on the stereoscopic image signal is displayed on display unit 330.

Imaging apparatus 110 generates, from the primary image signal (e.g. right-eye image signal), a new secondary image signal (e.g. left-eye image signal) paired with the primary image signal on the basis on the parallax information (depth map). Therefore, by correcting the parallax information (depth map), the stereoscopic effect (sense of depth) of the generated stereoscopic image can be adjusted. In the present exemplary embodiment, matching unit 370 (depth map generating unit 323) is configured to perform adjustment, such as correcting the parallax information (depth map), or increasing or suppressing the stereoscopic effect (sense of depth) of the stereoscopic image. The details are described later.

Feature point extracting unit 322 of matching unit 370 extracts a plurality of feature point candidates from the primary image signal and secondary image signal, selects two or more feature point candidates from the extracted feature point candidates, and sets the selected feature point candidates as feature points. Thus, a plurality of feature points are assigned to each of the primary image signal and secondary image signal.

A feature point means a region used as a mark when the primary image signal is compared with the secondary image signal. A feature point is also used when parallax information (depth map) is generated. Therefore, preferably, the region set as a feature point satisfies the following requirements:
(1) the region has a clear feature as a region used for comparison, is easily used for the comparison, and is easily extracted;
(2) the region exists commonly in the primary image signal and secondary image signal;
(3) the region is distributed as uniformly as possible in each of the primary image signal and secondary image signal; and
(4) the region is distributed as uniformly as possible in each of the subjects including a short-distance subject to a long-distance subject in the captured image.

Requirement 1 is based on the following reason. The region where the signal smoothly varies is difficult to be extracted. Therefore, it is difficult to set the region as a reference, and it is difficult to specify regions to be compared with each other in respective images. Preferably, the region set as a feature point is a region that is easily set as a reference and is easily specified in comparison. As such a region, a profile part of a subject can be employed, for example. Such a region can be easily extracted, by calculating the differential value of the luminance signal or the differential value of the color signal (color-difference signal), and comparing the calculation result with a predetermined threshold.

Requirement 2 is based on the following reason. As discussed above, the primary image is captured by primary imaging section 300 having an optical zoom function, and the secondary image is captured by secondary imaging section 310 having a single focus lens. Therefore, it is considered that a range larger than the range captured in the primary image is often captured in the secondary image. Therefore, when a feature point is set in the region captured only in the secondary image, the feature point cannot be compared. Therefore, preferably, the region existing commonly in the primary image signal and secondary image signal is set as a feature point.

Requirement 3 is based on the following reason. When feature points are concentrated in a specific region in an image, the comparison in the region can be performed at a relatively high accuracy, but the accuracy of the comparison in the other region is relatively low. Therefore, in order to prevent such unbalance, it is preferable that the feature points are distributed as uniformly as possible in each image. In the present exemplary embodiment, each of the primary image and secondary image is divided into nine regions by horizontal tripartition and vertical tripartition, and two through five feature points are set in each region, thereby preventing the unbalance. However, the present exemplary embodiment is not limited to this configuration. Any setting may be used as long as the unbalance of the feature points can be prevented.

Requirement 4 is based on the following reason. When the feature points are intensively set in a short-distance subject or are intensively set in a long-distance subject, the parallax information (depth map) generated by depth map generating unit 323 is also unbalanced, and a high-quality new secondary image signal (stereoscopic image signal) is difficult to be generated by image generating unit 325. In order to generate accurate parallax information (depth map), it is preferable that the feature points are distributed as uniformly as possible in each of the subjects including a short-distance subject to a long-distance subject. When requirement 3 is satisfied, requirement 4 can be considered to be substantially satisfied.

The region set as a feature point is difficult to be used for comparison when the region is excessively large, and is also difficult to be extracted when the region is excessively small. Therefore, preferably, the region is set to have an appropriate size in consideration of this problem.

Feature point extracting unit 322 extracts a feature point candidate from each image signal in consideration of these requirements, and sets a feature point. Then, feature point extracting unit 322 outputs the information (feature point information) related to the set feature point to angle-of-view adjusting unit 321 and image pattern determining unit 324.

It is preferable that all of these requirements are satisfied, but all of them do not need to be satisfied. The selection of requirements may be performed within a range where no problem arises in practical use. For example, feature point extracting unit 322 may be configured to assign priorities to the four requirements and extract feature point candidates so that the requirements are satisfied in the order from the highest priority to the lowest one. Alternatively, based on the outputs of one or more of face recognizing unit 327, scene determining unit 328, and motion detecting unit 329, the priorities may be changed, a requirement other than the above-mentioned ones may be added, or the extracting method of the feature point candidates may be changed.

Feature point extracting unit 322 may be configured to extract, as feature point candidates, all of the regions corresponding to the feature point candidates in each image signal, and set all of the regions as feature points. Alternatively, feature point extracting unit 322 may be configured to select, as feature points, a predetermined number of feature point candidates from the plurality of extracted feature point candidates in the order from the region satisfying the largest number of requirements or in the order from the region satisfying the highest priority.

Angle-of-view adjusting unit 321 receives a primary image signal output from primary imaging section 300 and a secondary image signal output from secondary imaging section 310. Angle-of-view adjusting unit 321 extracts, from the received image signals, image signals determined to have the same capturing range.

As discussed above, primary imaging section 300 can perform capturing using an optical zoom function, and secondary imaging section 310 performs capturing using a single focus lens. Therefore, when the imaging sections are set so that the angle of view of the primary image when primary optical unit 301 is set at a wide end is narrower than or equal to the angle of view of the secondary image, the range taken in the primary image is always included in the range taken in the secondary image. For example, the angle of view of the secondary image captured without optical zoom during imaging is wider than that of the primary image captured at the increased zoom magnification, and a range larger than that of the primary image is captured in the secondary image.

The “angle of view” means a range captured as an image, and is expressed generally as an angle.

Therefore, angle-of-view adjusting unit 321 extracts, from the secondary image signal, a part corresponding to the range (angle of view) taken as the primary image, using a generally used comparing/collating method such as pattern matching. At this time, by using the feature points set by feature point extracting unit 322, the accuracy of the comparison between the primary image signal and secondary image signal can be increased. Hereinafter, an image signal extracted from the secondary image signal is referred to as “cutout image signal”, and an image corresponding to the cutout image signal is referred to as “cutout image”. Therefore, the cutout image is an image corresponding to the range that is determined to be equal to the capturing range of the primary image by angle-of-view adjusting unit 321.

The difference (parallax) between the disposed position of primary optical unit 301 and that of secondary optical unit 311 causes a difference between the position of the subject in the primary image and that in the secondary image. Therefore, the possibility that the region in the secondary image corresponding to the primary image completely coincides with the primary image is low. Therefore, when angle-of-view adjusting unit 321 performs pattern matching, preferably, the secondary image signal is searched for the region most similar to the primary image signal, and this region is extracted from the secondary image signal and set as a cutout image signal.

Angle-of-view adjusting unit 321 performs contraction processing of reducing the number of pixels (signal quantity) by thinning out the pixels of both of the primary image signal and the cutout image signal. This is for the purpose of reducing the operation amount required for calculating the parallax information with subsequent depth map generating unit 323.

Angle-of-view adjusting unit 321 performs the contraction processing so that the number of pixels in the primary image signal after the contraction processing is equal to that in the cutout image signal after the contraction processing. This is for the purpose of reducing the operation amount and increasing the accuracy in the comparison processing between two image signals performed by subsequent depth map generating unit 323. For example, when the number of pixels (e.g. 3840×2160) of the cutout image signal is four times that (e.g. 1920×1080) of the primary image signal, and the primary image signal is contraction-processed so that the number of pixels thereof falls to one-fourth (e.g. 960×540), the cutout image signal is contraction-processed so that the number of pixels thereof falls to one-sixteenth (e.g. 960×540). When the contraction processing is performed, preferably, damage of the information is minimized by filtering processing or the like.

Angle-of-view adjusting unit 321 outputs the contraction-processed cutout image signal and the contraction-processed primary image signal to subsequent depth map generating unit 323. When the angle-of-view of the primary image is equal to that of the secondary image, the secondary image signal may be used as a cutout image signal as it is.

The operation of angle-of-view adjusting unit 321 is not limited to the above-mentioned operation. For example, when the angle-of-view of the primary image is wider than that of the secondary image, angle-of-view adjusting unit 321 may operate so as to extract a region corresponding to the capturing range of the secondary image from the primary image signal and generate a cutout image signal. When the capturing range of the primary image is different from that of the secondary image, angle-of-view adjusting unit 321 may operate so as to extract regions having the same capturing range from the primary image signal and secondary image signal, respectively, and output them to the subsequent stage.

In the present exemplary embodiment, the method used for comparing the primary image signal with the secondary image signal in angle-of-view adjusting unit 321 is not limited to the pattern matching. A cutout image signal may be generated using another comparing/collating method.

Angle-of-view adjusting unit 321 may perform image signal processing to the primary image signal and the secondary image signal so that the brightness (e.g. gamma characteristic, luminance of black, luminance of white, and contrast), white balance, and color phase (color shade, and color density) of the primary image are made to equal to those of the secondary image.

Image pattern determining unit 324 determines, based on the primary image signal, whether or not the primary image corresponds to a specific pattern, or whether or not the region corresponding to the specific pattern is included in the primary image.

The image or region corresponding to the specific pattern is an image or region where it is considered that a feature point is apt to be set incorrectly and hence the parallax information (depth map) is apt to include an error.

The image or region corresponding to the specific pattern is described below.

(1) The corresponding image is an image in which many regions similar to a region set as a feature point exist. As an example of such an image (or region), the following images can be taken:
1-1: an image having the same shapes or same patterns that are arranged regularly, for example, a captured image of arranged tiles, or a captured image of a wall having a lattice pattern; and
1-2: an image that has many regions similar to the region set as the feature point and makes the search for the feature point difficult, for example, a captured image of twigs, or a captured image of many leaves of a tree.
   (2) The corresponding image is an image in which the variation in the luminance signal or color signal (color-difference signal) is small and a feature point itself is difficult to be set. As an example of such an image (or region), the following images can be taken:
2-1: an image in which the variation in the luminance signal is small, for example, a captured image of a white wall; and
2-2: an image in which both of the variations in the luminance signal and color signal (color difference signal) are small, for example, a captured image of a blue sky having no cloud.
   (3) The corresponding image is an image in which the profile of a subject is not clear and it is difficult to set a feature point because the subject rapidly moves greatly or the variations in the luminance signal and color signal (color-difference) are smooth. As an example of such an image (or region), the following images can be taken:
3-1: an image in which a subject rapidly moves greatly, for example, a captured image of a moving dog or a captured image of a sporting person; and
3-2: an image in which the variations in the luminance signal and color signal (color-difference signal) are smooth, for example, a captured image of a sky at sunset.

Image pattern determining unit 324 determines, based on the primary image signal, whether or not the primary image corresponds to such a specific pattern, or whether or not the region corresponding to the specific pattern is included in the primary image. When the region corresponding to the specific pattern is included in the primary image, image pattern determining unit 324 determines the position and range of the region on the basis of the primary image signal. Image pattern determining unit 324 outputs these determination results to depth map generating unit 323. When the results are positive, image pattern determining unit 324 further outputs, to depth map generating unit 323, the information indicating that the reliability of the feature point set by feature point extracting unit 322 is low, or the information for identifying a feature point of low reliability. The information is referred to as “specific pattern determination information”.

Image pattern determining unit 324 performs the above-mentioned determination by selecting one or more from the followings:
a detection result by face recognizing unit 327;
a detection result by motion detecting unit 329;
a detection result by scene determining unit 328;
a histogram related to the luminance signal of the primary image signal;
a histogram related to the color signal (color-difference signal) of the primary image signal;
a signal obtained by extracting the profile part of the primary image signal; and
the optical zoom magnification of primary optical unit 301 and the distance (focusing distance) to a focused subject when the primary image to be determined is captured.
   The information required for the determination is included in the above-mentioned database, and the image pattern determining unit performs the determination by reference to the database.

Image pattern determining unit 324 may be configured to perform the above-mentioned determination on the basis of the secondary image signal or cutout image signal instead of the primary image signal. Alternatively, image pattern determining unit 324 may be configured to perform the above-mentioned determination of both of the primary image signal and one of secondary image signal and cutout image signal. The determination by image pattern determining unit 324 is not limited to the above-mentioned contents, but may be any determination as long as the reliability of the feature point can be determined.

Depth map generating unit 323 generates parallax information on the basis of the primary image signal and the cutout image signal that are contraction-processed by angle-of-view adjusting unit 321. Depth map generating unit 323 compares the contraction-processed primary image signal with the contraction-processed cutout image signal, and calculates the displacement between corresponding subjects in the two image signals—between corresponding pixels or between corresponding groups each of which is formed of a plurality of pixels. This “amount of displacement (displacement amount)” is calculated in the parallax direction. The parallax direction is, for example, the direction that is horizontal to the ground when the capturing is performed. The “displacement amount” is calculated in the whole of one image, and is associated with a pixel or block in the image to be calculated, thereby providing parallax information (depth map). Here, the one image is an image based on the contraction-processed primary image signal, or an image based on the contraction-processed cutout image signal.

In depth map generating unit 323, by using the feature point set by feature point extracting unit 322 when the primary image signal is compared with the cutout image signal, the accuracy in generating the parallax information (depth map) is increased.

Depth map generating unit 323 corrects the parallax information (depth map) on the basis of the determination results of image pattern determining unit 324 and scene determining unit 328.

As the correction example, the following examples can be employed.

(1) Regarding an image that is determined to be a captured image of a landscape by scene determining unit 328, the parallax information of a short-distance subject is decreased to reduce the stereoscopic effect (sense of depth), and the parallax information of a long-distance subject is increased to increase the stereoscopic effect (sense of depth). Thus, the stereoscopic effect (sense of depth) can be enhanced so that the long-distance subject seems farther in the generated stereoscopic image.
(2) Regarding an image that is determined to be a captured image of a person by scene determining unit 328, the parallax information of a focused subject (person image) is corrected so as to provide a distance at which a viewing person of the stereoscopic image can easily bring the subject into focus. This distance is about 2 to 5 m, for example. With a subject corresponding to the background of the focused subject (person image), the parallax information is corrected so as to reduce the sense of distance to the focused subject. When the stereoscopic effect (sense of depth) is excessively enhanced, the person image is apt to become an unnatural stereoscopic image. However, this correction can appropriately suppress the stereoscopic effect (sense of depth) of the stereoscopic image, and hence a stereoscopic image can be generated which allows the viewing person to view the person image with a natural stereoscopic effect (sense of depth).
(3) Regarding an image that is determined to be a captured image of a scene having much motion by scene determining unit 328, or an image that is determined to correspond to a specific pattern by image pattern determining unit 324, the possibility that the parallax information (depth map) includes an error is high, and hence the parallax information is corrected so as to reduce the stereoscopic effect (sense of depth). Furthermore, regarding an image that is determined to include a region corresponding to the specific pattern by image pattern determining unit 324, the possibility that parallax information of the region and a region around it includes an error is high. When an output from image pattern determining unit 324 includes information specifying a feature point of low reliability, the possibility that parallax information of the feature point and a region around it includes an error is high. Therefore, the parallax information is corrected so as to reduce the stereoscopic effect (sense of depth) of the regions, and the parallax information of the region around them is corrected so as to prevent unnaturalness from occurring in the stereoscopic image.
(4) Regarding an image other than above-mentioned images, the parallax information (depth map) is not corrected. However, depth map generating unit 323 may be configured to perform a predetermined correction or a correction commanded by the user and to enhance or reduce the stereoscopic effect (sense of depth).

The correction data for correcting the parallax information is previously included in the database. Depth map generating unit 323 acquires the correction data from the database and corrects the parallax information, on the basis of the determination result by scene determining unit 328 and the determination result by image pattern determining unit 324.

In the present exemplary embodiment, the parallax information (depth map) is generated in association with the contraction-processed primary image signal. However, the parallax information (depth map) may be generated in association with the contraction-processed cutout image signal.

When two image signals are compared with each other, “displacement amount” cannot be calculated between the regions that do not have corresponding parts. Therefore, a code indicating indefiniteness is set for such regions, or a predetermined numerical value is set for them.

The method of calculating parallax information (displacement amount) from two images having parallax, and the method of generating a new image signal based on the parallax information are publicly known, and are described in Patent Literature 1, for example. Therefore, detailed descriptions are omitted.

Next, the operation of imaging a stereoscopic image with imaging apparatus 110 is described with reference to drawings. One example of the processing method of an image signal in each function block is described with reference to the drawings.

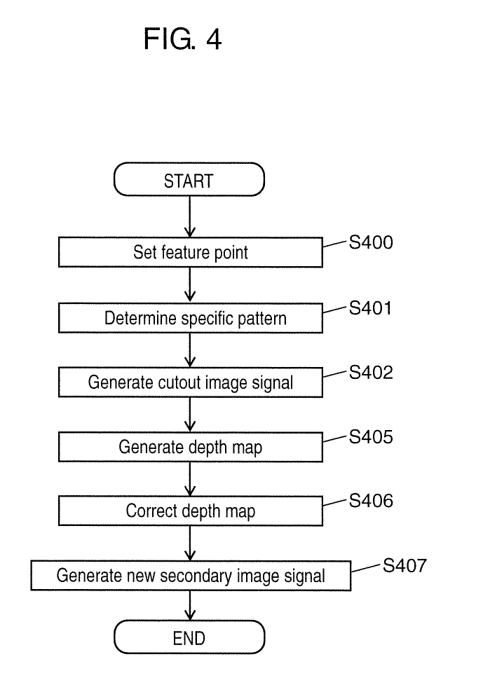

FIG. 4 is a flowchart illustrating the operation when a stereoscopic image is captured by imaging apparatus 110 in accordance with the first exemplary embodiment.

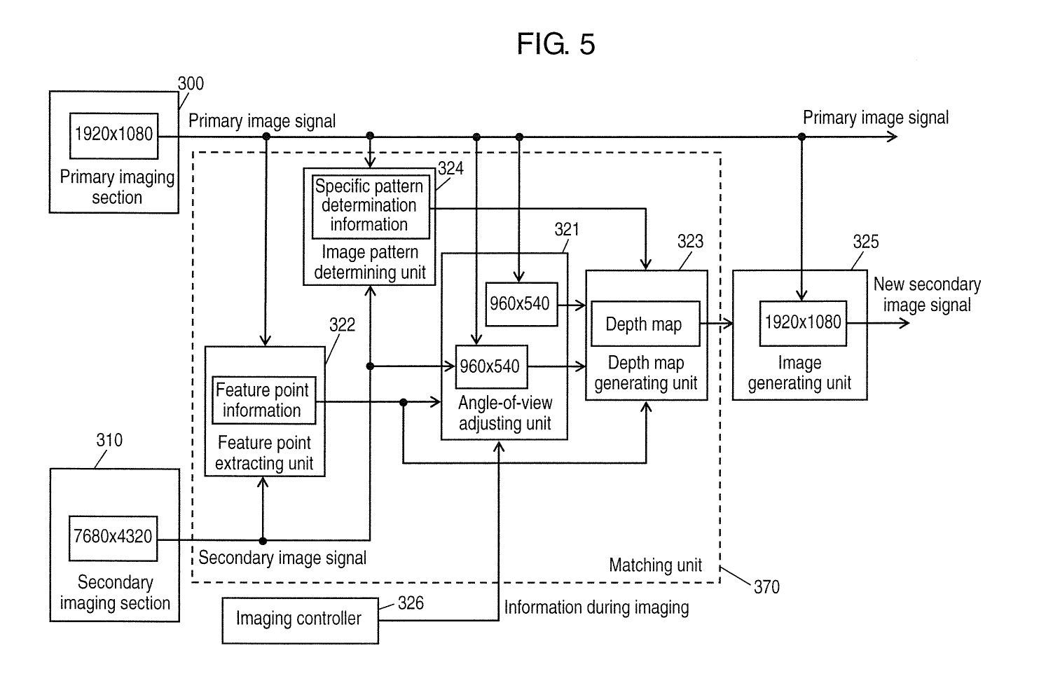

FIG. 5 is a diagram schematically showing one example of the processing flow of an image signal in imaging apparatus 110 in accordance with the first exemplary embodiment.

The following description is performed as one example, assuming that primary imaging section 300 outputs a primary image signal having 1920×1080 pixels and secondary imaging section 310 outputs a secondary image signal having 7680×4320 pixels, as shown in FIG. 5. Repeated descriptions are omitted.

The numerical values of FIG. 5 are simply one example. The present exemplary embodiment is not limited to these numerical values.

When a stereoscopic image is captured, imaging apparatus 110 mainly performs the following operation.

Feature point extracting unit 322 assigns a feature point to each of the primary image signal and secondary image signal, and outputs information (feature point information) related to the assigned feature points to angle-of-view adjusting unit 321 and image pattern determining unit 324 (step S400).

Based on the primary image signal, image pattern determining unit 324 determines whether or not the primary image corresponds to a specific pattern, whether or not the region corresponding to the specific pattern is included in the primary image, and the reliability of the feature point set in step S400. Then, image pattern determining unit 324 outputs the determination results (specific pattern determination information) to depth map generating unit 323 (step S401).

Furthermore (not shown in FIG. 4 and FIG. 5), scene determining unit 328 determines which scene is photographed in the primary image, and outputs the determination result to matching unit 370.

Angle-of-view adjusting unit 321 extracts, from the secondary image signal, a part corresponding to the range (angle of view) captured as the primary image, and generates a cutout image signal (step S402).

Imaging controller 326 of image signal processor 320 controls the optical zoom of primary optical unit 301 via primary optical controller 303. Therefore, image signal processor 320 can acquire, as supplementary information of the primary image, the zoom magnification of primary optical unit 301 when the primary image is captured. In secondary optical unit 311, the optical zoom is not allowed, and hence the zoom magnification when the secondary image is captured is fixed. Based on the information, angle-of-view adjusting unit 321 calculates the difference between the angle of view of the primary image and that of the secondary image. Based on the calculation result, angle-of-view adjusting unit 321 identifies and cuts out, from the secondary image signal, the region corresponding to the capturing range (angle of view) of the primary image.

At this time, angle-of-view adjusting unit 321 firstly cuts out a range that is slightly larger than the region corresponding to the angle of view of the primary image (for example, a range larger by about 10%). This is because a fine displacement can occur between the center of the primary image and that of the secondary image.

Next, angle-of-view adjusting unit 321 applies a generally used pattern matching to the cutout range, and identifies the region corresponding to the capturing range of the primary image and cuts out the region again. At this time, using the feature point set in step S400 allows accurate comparison.

Angle-of-view adjusting unit 321 firstly vertically compares both image signals with each other, and then horizontally compares both image signals with each other. This sequence may be reversed. Thus, angle-of-view adjusting unit 321 extracts, from the secondary image signal, the region substantially equal to the capturing range of the primary image signal, and generates a cutout image signal.

Thus, the cutout image signal can be generated at a relatively high speed by arithmetic processing of a relatively low load. A method such as pattern matching for comparing two images of different angles of view or resolutions with each other and identifying the regions having a common capturing range is a generally known method, so that the descriptions thereof are omitted.

The exemplary embodiment is not limited to this configuration. A cutout image signal may be generated only by pattern matching, for example.

Next, angle-of-view adjusting unit 321 performs contraction processing so that each of the primary image signal and cutout image signal has a predetermined number of pixels. FIG. 5 shows the example in which the predetermined number is 960×540.

When the number of pixels in the primary image signal is 1920×1080, by contraction-processing the primary image signal to a half in each of the horizontal direction and vertical direction, the number of pixels in the primary image signal after the contraction processing can be decreased to 960×540.

The number of pixels in the cutout image signal depends on the magnitude of the optical zoom magnification of primary imaging section 300. As the zoom magnification when the primary image is captured increases, the number of pixels in the cutout image signal decreases. For example, when the number of pixels in the cutout image signal is 3840×2160, by contraction-processing the cutout image signal to one-fourth in each of the horizontal direction and vertical direction, the number of pixels in the cutout image signal after the contraction processing can be decreased to 960×540.

The sequence of the processing may be changed. For example, the sequence may be employed in which the contraction processing is firstly performed, the contracted image signals are compared with each other, and then a cutout image signal is generated. Alternatively, the sequence may be employed in which comparison in the vertical direction is firstly performed, contraction processing is performed, and then comparison in the horizontal direction is performed.

Next, depth map generating unit 323 generates parallax information (depth map), on the basis of the primary image signal and cutout image signal contraction-processed by angle-of-view adjusting unit 321 (step S405).

Next, depth map generating unit 323 reads a correction value from the database stored in storage device 340 on the basis of the determination result in step S401, and corrects the parallax information (depth map) generated in step S405 (step S406).

For the image having a feature point determined to have low reliability in step S401, the parallax information (depth map) is corrected so as to suppress the stereoscopic effect (sense of depth).

Depth map generating unit 323 may not correct the parallax information (depth map) generated in step S405, depending on the determination result in step S401.

In order to prepare for the subsequent processing, depth map generating unit 323 expands the parallax information (depth map) in accordance with the number of pixels in the primary image signal. Hereinafter, the expanded parallax information (depth map) is referred to as “expanded depth map”. For example, when the parallax information (depth map) is generated based on the image signal having 960×540 pixels and the number of pixels in the primary image is 1920×1080, the parallax information (depth map) is expanded to double in each of the horizontal direction and vertical direction, thereby generating an expanded depth map.

The sequence of the correction processing and the expansion processing may be reversed.

Next, based on the parallax information (expanded depth map) generated by depth map generating unit 323 in step S406, a new secondary image signal paired with the primary image signal in the stereoscopic image signal is generated from the primary image signal by image generating unit 325 (step S407). Image generating unit 325, based on the expanded depth map, generates a new secondary image signal having 1920×1080 pixels from the primary image signal having 1920×1080 pixels, for example.

Then, image generating unit 325 outputs a pair of primary image signal and new secondary image signal, as a stereoscopic image signal. The number of pixels in each image signal and the number of pixels in the image signal after the contraction processing are not limited to the above-mentioned numerical values.

The processings from step S400 to step S406 may be performed using only the luminance signal of the image signal. That is because this method can perform arithmetic processing with a lower load and can perform each processing more accurately than the method of performing processing for each of three primary colors of RGB (red-green-blue). However, each processing may be performed using the luminance signal and color signal (color difference signal) of the image signal, or each processing may be performed for each of three primary colors of RGB.

Imaging apparatus 110 may be configured to display, on display unit 330, the parallax information (depth map) generated by depth map generating unit 323, and allow the user to manually correct the parallax information (depth map). Alternatively, imaging apparatus 110 may be configured to temporarily generate a new secondary image signal on the basis of the parallax information (depth map) that is not corrected, display the stereoscopic image based on the new secondary image signal on display unit 330, and allow the user to manually correct a part where the stereoscopic effect (sense of depth) is unnatural. Furthermore, the new secondary image signal based on the parallax information (depth map) that is corrected manually may be output as a final new secondary image signal from image generating unit 325.

Furthermore, imaging apparatus 110 may be configured so that the correction of the parallax information (depth map) is performed only when the user permits the correction.

Preferably, the zoom magnification of primary optical unit 301 and the resolution of secondary imaging element 312 are set so that the resolution of the cutout image signal when primary optical unit 301 is set at a telescopic end is higher than or equal to the resolution of the primary image signal. This is for the purpose of preventing the possibility that, when primary optical unit 301 is set at the telescopic end, the resolution of the cutout image signal becomes lower than that of the primary image signal. However, the present exemplary embodiment is not limited to this configuration.

Preferably, secondary optical unit 311 is configured to have an angle of view that is substantially equal to or wider than the angle of view obtained when primary optical unit 301 is set at a wide end. This is for the purpose of preventing the possibility that, when primary optical unit 301 is set at the wide end, the angle of view of the primary image becomes wider than that of the secondary image. However, the present exemplary embodiment is not limited to this configuration. The angle of view of the primary image when primary optical unit 301 is set at the wide end may be wider than that of the secondary image.

[1-3. Effect or the Like]

Thus, in the present exemplary embodiment, imaging apparatus 110 includes the following components:
primary imaging section 300 configured to capture a primary image and output a primary image signal;
secondary imaging section 310 configured to capture a secondary image having an angle of view wider than or equal to that of the primary image at a resolution higher than that of the primary image, and output a secondary image signal; and
image signal processor 320.
   Image signal processor 320 is configured to, based on the primary image signal, cut out at least a part from the secondary image signal and generate a cutout image signal; determine whether or not either one of the primary image signal and the secondary image signal has a specific pattern; calculate parallax information based on the primary image signal and the cutout image signal, and correct the parallax information when the either one image signal is determined to have the specific pattern; and generate a new secondary image signal based on the primary image signal and one of the parallax information and the corrected parallax information (parallax information after the correction).

Thus, imaging apparatus 110 can generate a high-quality stereoscopic image.

In order to acquire (generate) a high-quality stereoscopic image, it is preferable that, when a right-eye image and a left-eye image are captured in a pair, the imaging condition such as the angle of view (capturing range), resolution (number of pixels), and zoom magnification are aligned between the pair of images and are set constant as much as possible between the pair of images.

In imaging apparatus 110 of the present exemplary embodiment, however, primary imaging section 300 has an optical zoom function, and secondary imaging section 310 does not have an optical zoom function but has a single focus lens. Thus, the specification of the optical system of primary imaging section 300 is different from that of secondary imaging section 310.

Furthermore, the specification of the imaging element in primary imaging section 300 is different from that in secondary imaging section 310.

In imaging apparatus 110, therefore, even when the primary image captured by primary imaging section 300 is used as the right-eye image without change and the secondary image captured by secondary imaging section 310 is used as the left-eye image without change, it is difficult to acquire a high-quality stereoscopic image (stereoscopic video).

In the present exemplary embodiment, therefore, imaging apparatus 110 is configured as discussed. In other words, the primary image signal captured by primary imaging section 300 is set as the right-eye image signal, and the new secondary image signal generated from the primary image signal using the parallax information (depth map) is set as the left-eye image signal. Thus, a stereoscopic image (stereoscopic video) is generated.

This method can generate a right-eye image and left-eye image that are substantially the same as the right-eye image and left-eye image that are captured (or video-shot) by a pair of ideal imaging sections. Here, the ideal imaging sections have the same imaging condition, such as an optical characteristic and a characteristic of the imaging element.

At this time, in order to generate a high-quality new secondary image, it is required to generate accurate parallax information. Depending on the scene taken in the captured image, however, it is sometimes difficult to generate accurate parallax information.

In the present exemplary embodiment, therefore, imaging apparatus 110 is configured as discussed, and the parallax information is corrected for an image signal in which the possibility of incorrectly generating the parallax information is determined to be high. A correction corresponding to the captured scene can be applied to the parallax information. Thus, the quality of the generated parallax information can be improved, and hence a high-quality stereoscopic image can be generated.

### Another Exemplary Embodiment

Thus, the first exemplary embodiment has been described as an example of a technology disclosed in the present application. However, the disclosed technology is not limited to this exemplary embodiment. The disclosed technology can be also applied to exemplary embodiments having undergone modification, replacement, addition, or omission. A new exemplary embodiment may be created by combining the components described in the first exemplary embodiment.

Another exemplary embodiment is described hereinafter.

The first exemplary embodiment, as shown in FIG. 1, has described the example in which imaging apparatus 110 is configured so that primary lens unit 111 is disposed on the right side of the imaging direction and a primary image is set as an image of right-eye view, and secondary lens unit 112 is disposed on the left side of the imaging direction and a secondary image is set as an image of left-eye view. However, the present disclosure is not limited to this configuration. For example, imaging apparatus 110 may be configured so that a primary image signal is set as a left-eye image signal and a new secondary image signal is set as a right-eye image signal.

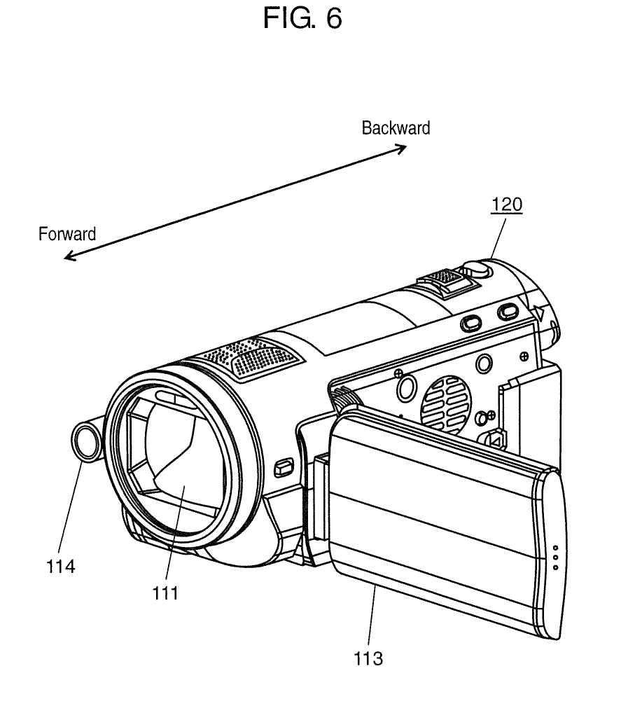

FIG. 6 is an outward appearance of imaging apparatus 120 in accordance with another exemplary embodiment. For example, imaging apparatus 120 may be configured so that primary lens unit 111 is disposed on the left side of the imaging direction and a primary image is set as an image of left-eye view, and secondary lens unit 114 is disposed on the right side of the imaging direction and a secondary image is set as an image of right-eye view. In this configuration, the right in the first exemplary embodiment is replaced with the left, and the left in the first exemplary embodiment is replaced with the right.

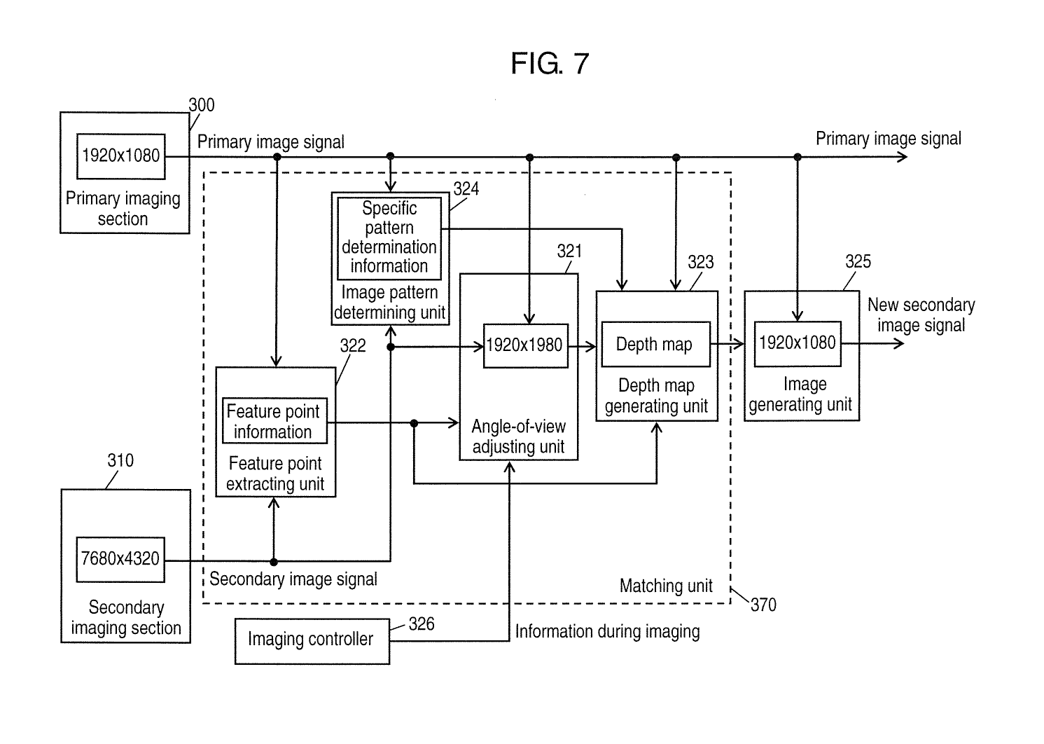

The first exemplary embodiment has described the example in which angle-of-view adjusting unit 321 contraction-processes the image signal. However, the present disclosure is not limited to this configuration. FIG. 7 is a diagram schematically showing one example of the processing flow of an image signal in the imaging apparatus in accordance with another exemplary embodiment. For example, angle-of-view adjusting unit 321 does not perform contraction processing, and may generate a cutout image signal so that the cutout image signal has the same number of pixels as those (e.g. 1920×1080 pixels) of the primary image signal. In this configuration, depth map generating unit 323 generates parallax information (depth map) based on the number of pixels, an that an expanded depth map does not need to be generated and a more accurate new secondary image can be generated.

The present exemplary embodiment has described the example where the imaging apparatus is configured so that primary imaging section 300 captures a primary image and secondary imaging section 310 captures a secondary image. However, the imaging apparatus may be configured to include a primary image input unit instead of primary imaging section 300, include a secondary image input unit instead of secondary imaging section 310, acquire a primary image via the primary image input unit, and acquire a secondary image via the secondary image input unit, for example.

The configuration and operation shown in the first exemplary embodiment are applicable to video shooting. However, when the primary image signal and secondary image signal are video signals and have different frame rates, it is preferable that angle-of-view adjusting unit 321 aligns the image signal having the lower frame rate with the image signal having the higher frame rate to increase the lower frame rate, thereby making both image signals have the same frame rate. For example, when the frame rate of the primary image signal is 60 Hz and that of the secondary image signal is 30 Hz, the frame rate of the secondary image signal or cutout image signal is increased to 60 Hz. The frame rate converting method used at this time may be a publicly known method. Thus, regarding a video signal, a depth map is generated in a state where comparison is easy. Thus, even during the video shooting, parallax information (depth map) can be generated at a high accuracy.

Primary optical unit 301 (primary lens group 201) and secondary optical unit 311 (secondary lens group 211) are not limited to the configuration shown in the first exemplary embodiment. For example, primary optical unit 301 (primary lens group 201) may include a deep-focus lens requiring no focus adjustment, instead of a focus lens adjustable in focus. Alternatively, secondary optical unit 311 (secondary lens group 211) may include a focus lens adjustable in focus, instead of a deep-focus lens requiring no focus adjustment. In this case, preferably, a second actuator having a motor configured to drive the focus lens is disposed in secondary imaging unit 210. The motor is controlled by a control signal output from CPU 220. Secondary optical unit 311 may be configured to include an optical diaphragm for adjusting the quantity of the light that is received by secondary imaging element 312 (secondary CCD 212).

Secondary optical unit 311 may include an optical zoom lens instead of the single focus lens. In this case, for example, when a stereoscopic image is captured by the imaging apparatus, secondary optical unit 311 may be automatically set at a wide end.

The imaging apparatus may be configured so that, when primary optical unit 301 is set at a telescopic end, the cutout image signal has a resolution lower than that of the primary image signal. In this case, for example, the imaging apparatus may be configured so that, when the resolution of the cutout image signal becomes lower than or equal to that of the primary image signal in the process of increasing the zoom magnification of primary optical unit 301, the capturing mode is automatically switched from a stereoscopic image to a normal image.

The imaging apparatus may have the following configuration:
the imaging apparatus includes a switch that is turned on when monitor 113 is opened to a position appropriate for capturing a stereoscopic image, and is turned off in the other cases; and
a stereoscopic image can be captured only when the switch is turned on.

The specific numerical values of the exemplary embodiments are simply one example of the exemplary embodiments. The present disclosure is not limited to these numerical values. Preferably, each numerical value is set at an optimal value in accordance with the specification or the like of the image display device.

The present disclosure is applicable to an imaging apparatus that includes a plurality of imaging units and can capture an image for stereoscopic vision. Specifically, the present disclosure is applicable to a digital video camera, a digital still camera, a mobile phone having a camera function, or a smartphone that can capture an image for stereoscopic vision.

What is claimed is:

1. An image generating apparatus comprising
an image signal processor configured to:
receive a primary image signal and a secondary image signal, and, based on the primary image signal, cut out at least a part from the secondary image signal and generate a cutout image signal, the secondary image signal having a resolution higher than a resolution of the primary image signal and an angle of view wider than or equal to an angle of view of the primary image signal;
determine whether or not either one of the primary image signal and the secondary image signal has a specific pattern;
calculate parallax information based on the primary image signal and the cutout image signal, and correct the parallax information when the either one image signal is determined to have the specific pattern; and
generate a new secondary image signal based on the primary image signal and one of the parallax information and the corrected parallax information.

2. The image generating apparatus according to claim 1, wherein
the image signal processor comprises:
a feature point extracting unit configured to extract, from the primary image signal and the secondary image signal, a feature point common between the primary image signal and the secondary image signal;
an angle-of-view adjusting unit configured to, based on the feature point and the primary image signal, cut out at least a part from the secondary image signal and generate the cutout image signal;
an image pattern determining unit configured to determine, by reference to a database including information required for determination, whether or not either one of the primary image signal and the secondary image signal has the specific pattern;
a depth map generating unit configured to calculate the parallax information based on the primary image signal and the cutout image signal and generate a depth map, and to correct the parallax information when the image pattern determining unit determines that the either one image signal has the specific pattern; and
an image generating unit configured to generate the new secondary image signal based on the primary image signal and one of the parallax information and the corrected parallax information.

3. An imaging apparatus comprising:
a primary imaging section configured to capture a primary image and output a primary image signal;
a secondary imaging section configured to capture a secondary image at a resolution higher than a resolution of the primary image and output a secondary image signal, the secondary image having an angle of view wider than or equal to an angle of view of the primary image; and
an image signal processor configured to:
based on the primary image signal, cut out at least a part from the secondary image signal and generate a cutout image signal;
determine whether or not either one of the primary image signal and the secondary image signal has a specific pattern;
calculate parallax information based on the primary image signal and the cutout image signal, and correct the parallax information when the either one image signal is determined to have the specific pattern; and
generate a new secondary image signal based on the primary image signal and one of the parallax information and the corrected parallax information.

4. The imaging apparatus according to claim 3, wherein
the image signal processor comprises:
a feature point extracting unit configured to extract, from the primary image signal and the secondary image signal, a feature point common between the primary image signal and the secondary image signal;
an angle-of-view adjusting unit configured to, based on the feature point and the primary image signal, cut out at least a part from the secondary image signal and generate the cutout image signal;
an image pattern determining unit configured to determine, by reference to a database including information required for determination, whether or not either one of the primary image signal and the secondary image signal has the specific pattern;
a depth map generating unit configured to calculate the parallax information based on the primary image signal and the cutout image signal and generate a depth map, and to correct the parallax information when the image pattern determining unit determines that the either one image signal has the specific pattern; and
an image generating unit configured to generate the new secondary image signal based on the primary image signal and one of the parallax information and the corrected parallax information.

5. The imaging apparatus according to claim 3, wherein
the primary imaging section includes:
a primary optical unit having an optical zoom function; and
a primary imaging element configured to convert light having passed through the primary optical unit into an electric signal and output the primary image signal, and
the secondary imaging section includes:
a secondary optical unit having an angle of view wider than or equal to an angle of view of the primary optical unit; and
a secondary imaging element configured to convert light having passed through the secondary optical unit into an electric signal at a resolution higher than a resolution of the primary imaging element, and output the secondary image signal.

6. An image generating method comprising:
based on a primary image signal, cutting out at least a part from a secondary image signal and generating a cutout image signal, the secondary image signal having a resolution higher than a resolution of the primary image signal and an angle of view wider than or equal to an angle of view of the primary image signal;
determining whether or not either one of the primary image signal and the secondary image signal has a specific pattern;
calculating parallax information based on the primary image signal and the cutout image signal, and correcting the parallax information when the either one image signal is determined to have the specific pattern; and
generating a new secondary image signal based on the primary image signal and one of the parallax information and the corrected parallax information.

7. The image generating method according to claim 6, comprising:
extracting, from the primary image signal and the secondary image signal, a feature point common between the primary image signal and the secondary image signal; and
based on the feature point and the primary image signal, cutting out at least a part from the secondary image signal and generating the cutout image signal.
